(19) United States
(12) Patent Application Publication
(10) Pub. No.: US 2025/0023414 A1
(43) Pub. Date: Jan. 16, 2025

(54) ELECTRIC MOTOR AND COOLING FAN CONTAINING SUCH AN ELECTRIC MOTOR

(71) Applicant: Brose Fahrzeugteile SE & Co. Kommanditgesellschaft, Würzburg, Würzburg (DE)

(72) Inventors: Saiprakash NAIK, Pune (IN); Chitresh KAPLE, Pune (IN); Vishal ZADE, Bhosari Pune (IN); Miroslav BORZANOVIC, Belgrade (RS)

(21) Appl. No.: 18/901,260

(22) Filed: Sep. 30, 2024

Related U.S. Application Data
(63) Continuation of application No. PCT/EP2023/057892, filed on Mar. 28, 2023.

(30) Foreign Application Priority Data
Mar. 31, 2022 (DE) 10 2022 203 218.7

(51) Int. Cl. H02K 3/50; H02K 3/28; H02K 7/14

(52) U.S. Cl. CPC H02K 3/50; H02K 3/28; H02K 7/14; H02K 2203/06

(57) ABSTRACT

An electric motor, in particular a cooling fan motor of a motor vehicle, has a stator with a stator winding. The winding ends of the stator winding project beyond the stator in the form of phase connections and are oriented in an axial direction in pairs. The motor further has a rotor which is rotatably mounted relative to the stator, a motor support with through-openings for the phase connections, a connection cable with connection contacts for contacting the winding ends, and a number of wire holders, through which the winding ends are guided in pairs and thus in a mutually facing orientation.

### CROSS-REFERENCE TO RELATED APPLICATION

This application is a continuation, under 35 U.S.C. § 120, of copending International Patent Application PCT/EP2023/057892, filed Mar. 28, 2023, which designated the United States; this application also claims the priority, under 35 U.S.C. § 119, of German Patent Application DE 10 2022 203 218.7, filed Mar. 31, 2022; the prior applications are herewith incorporated by reference in their entireties.

### FIELD AND BACKGROUND OF THE INVENTION

The invention relates to an electric motor, in particular a brushless electric motor as an internal-rotor motor, preferably a cooling fan motor of a motor vehicle. It further relates to a cooling fan of a motor vehicle, having such an electric motor.

With the foregoing and other objects in view there is provided, in accordance with the invention,

Such an electric motor usually contains a rotor that is rotatably mounted with respect to a stationary stator. In a brushless electric motor, the stator is provided with a stator winding or rotating-field winding, with which a magnetic rotating field is generated as a result of the application of an alternating current thereto. The rotor arranged in the substantially hollow cylindrical stator is generally fitted with permanent magnets, which generate a rotor magnetic field interacting with the rotating field of the stator.

In a brushless electric motor, the alternating current provided to feed the stator winding is usually generated from a direct current by means of a converter (inverter). The converter, together with associated control electronics, can be accommodated in an electronic compartment which is integrated into the motor housing. If the control electronics or the converter (inverter) are provided outside the motor, then the typically three-phase energization of the stator winding is carried out by means of a connecting cable or wiring harness having a number of connecting contacts corresponding to the number of phases. The winding ends of the stator winding, serving as phase connections, are usually guided to these connecting contacts in pairs.

The electrical connection of the phase connections to the connecting contacts is generally carried out in a welding process or by means of a welding method. The problem here is, firstly, reliable orientation of the winding ends serving as phase connections and, secondly, the proper positioning thereof on or in the respective connecting contact during the welding process.

### SUMMARY OF THE INVENTION

The invention is based on the object of specifying an electric motor of the aforementioned type in which reliable orientation and positioning of the winding ends of a stator winding serving as phase connections on associated connecting contacts is made possible, in particular during a welding process. Furthermore, a cooling fan of a motor vehicle having such an electric motor is to be specified.

This object is achieved according to the invention by the features of the independent electric motor claim and by the features of the independent cooling fan claim. Advantageous variants, refinements and developments form the subject matter of the subordinate claims.

With the foregoing and other objects in view there is provided, in accordance with the invention, an electric motor. The electric motor contains a stator overmolded with a plastic jacket. The stator has a stator winding with winding ends. The winding ends project beyond the stator at one end as phase connections and are aligned axially in pairs. A rotor is rotatably mounted about an axis of rotation with respect to the stator. A motor support has a plurality of passage openings which correspond to a number of the phase connections. A connecting cable with connecting contacts for making contact with the winding ends is provided. A plurality of wire holders is provided and corresponds to the number of the phase connections disposed on the one end of the stator. Through the wire holders the winding ends are guided in pairs.

The electric motor is in particular provided and configured as a drive motor (cooling fan motor) for a cooling fan of a motor vehicle. The electric motor has a stator with a stator winding and a rotor and an in particular plate-like and/or half-shell-shaped motor support and also a connecting cable (wiring harness) having connecting contacts, also designated as contact elements below. In addition, the electric motor suitably has an in particular screw-fastened base plate held on the motor support for holding and/or positioning the connecting contacts (contact elements).

The stator suitably has a main stator body, for example formed from a laminated core, with radially inwardly directed stator teeth, on which coils of the stator winding are arranged. The stator or its main stator body is provided with a plastic jacket, for example overmolded with a plastic.

The rotor, which can likewise be formed from a laminated core and is fitted with permanent magnets, is rotatably mounted about an axis of rotation with respect to the stator.

The stator winding, which is preferably formed from the interconnected coils, has winding ends, which project (axially) beyond the stator at one end in pairs as phase connections. In other words, the winding ends of the stator winding provided as connection pairs for the respective phase connection project axially beyond the stator or its preferably overmolded main stator body at one annular edge on the front face (based on the motor or rotor axis of rotation).

The electric motor additionally has a number of wire holders corresponding to the number of phase connections, which are arranged and held at one end of the stator, in particular on its annular edge on the front face. By means of these wire holders, the winding ends are led through in pairs and are guided into a mutually facing alignment, in particular from a parallel orientation. The wire holders align the accommodated winding ends, preferably with positive guidance, with a common tip. In other words, the winding ends are guided, in particular positively guided, by means of the wire holder in such a way that their distance from one another decreases, starting from the inlet into the wire holder to its outlet. In this orientation, the winding ends projecting out of the wire holder are guided on or into the connecting contacts, in order to be contacted on or by the latter, in particular in a welding process.

The wire holders are in particular arranged on the annular edge on the front face of the stator or the main stator body. The motor support has a number of passage openings corresponding to the number of phase connections, via which the winding ends aligned by the wire holders are guided to the connecting contacts. The base plate that is suitably provided has through openings aligning with the passage openings of the motor support for the winding ends aligned by means of the wire holders. The base plate preferably has press-in slots for holding and/or positioning the connecting contacts.

In an advantageous refinement, the respective wire holder has a plate-like contact portion and a guide portion molded thereon for the winding ends of the stator winding, preferably each to be aligned as a connection pair. The respective connection pair forms one of the phase connections. Expediently, at least one pin-like joining element is molded onto the contact portion, which is inserted into a joining contour of the plastic jacket on the front face to hold the wire holder on the stator.

According to a suitable refinement, the respective wire holder has a guide contour holding the winding ends, which tapers conically toward the motor support. In a particularly advantageous embodiment, the respective wire holder has at least two passage or guide channels extending at an angle or obliquely relative to one another for each one of the winding ends of a connection pair of the stator winding or rotating-field winding. Particularly expediently, the respective wire holder or its respective passage channel has inlet openings at a distance from one another for the winding ends and outlet openings at a distance from one another, via which the winding ends emerge from the wire holder in the proper orientation at an angle to one another. The distance between the outlet openings is smaller than the distance between the inlet openings.

In a suitable refinement of the cable-side connecting contacts or contact elements provided and configured to make contact with the phase connections, these are bent in the shape of a hook. As a result, a connecting leg assigned to the connecting cable and a clamping or free leg bent over approximately in a U shape with respect to the connecting leg are formed. In the assembled state of the electric motor, the winding ends aligned by means of the wire holders and emerging from the latter at the free end are guided between the connecting leg and the free or clamping leg of the connecting contact (contact element) that extends at a defined distance from the latter. In this position, the winding ends can be contacted reliably, for example by means of welding tools, to the cable-side connecting contacts, preferably implemented as connecting hooks. Because of the alignment of the winding ends that is effected by the wire holders, one of the winding ends is reliably prevented from escaping from the connecting contacts or from the connecting hooks in the course of the contact-making or the welding process or from being able to deviate into a position that is unfavorable for making reliable contact.

To further improve the positioning of the aligned winding ends in or on the respective connecting contact (contact element), in particular between the legs of the connecting hook, the connecting contact has at least one contact element as a positioning aid for at least one of the winding ends. The preferably molded-on contact element is expediently a supporting stud or supporting cone shaped out of the connecting leg and elevated or projecting in the direction of the free or clamping leg of the connecting contact or the connecting hook.

The base plate, preferably produced from a plastic, suitably has a number of press-in slots corresponding to the number of connecting contacts (contact elements) of the connecting cable to hold and/or position the cable-side connecting contacts in the manner of a press fit. The press-in slots are expediently formed between axially protruding webs or ribs, which are molded on the base plate or shaped out of the latter.

Other features which are considered as characteristic for the invention are set forth in the appended claims.

Although the invention is illustrated and described herein as embodied in an electric motor and a cooling fan containing such an electric motor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, exploded, perspective view of a brushless electric motor containing a stator, a rotor, a motor support and a base plate for a connecting cable having hook-shaped connecting contacts for making contact with winding ends of a stator winding;

FIG. 2 is a perspective view of the electric motor according to FIG. 1 with the connecting cable before making contact between the hook-shaped connecting contacts and the winding ends of the stator winding;

FIG. 3 is a perspective view of a wire holder for the winding ends of the stator winding that are used as phase connections;

FIGS. 4A and 4b are different sectional views of details of the stator in the area of a wire holder for the winding ends that are held in pairs in the hook-shaped connecting contact, with a view of a mechanical interface between the wire holder and the stator and with a view into passage channels of the wire holder for the winding ends; and

FIG. 5 is detailed perspective view of the connection point of the winding ends held in the hook-shaped connecting contact as a conically tapering connection pair.

Mutually corresponding parts and sizes are always provided with the same reference signs in all the figures.

### DETAILED DESCRIPTION OF THE INVENTION

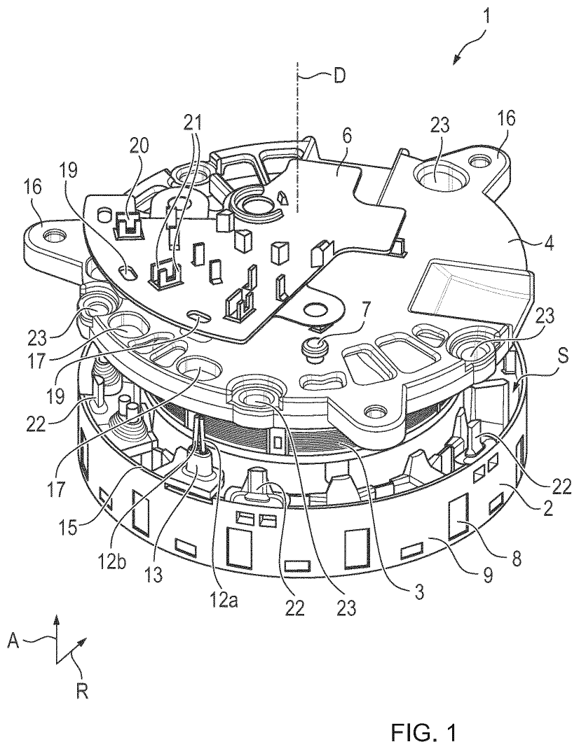

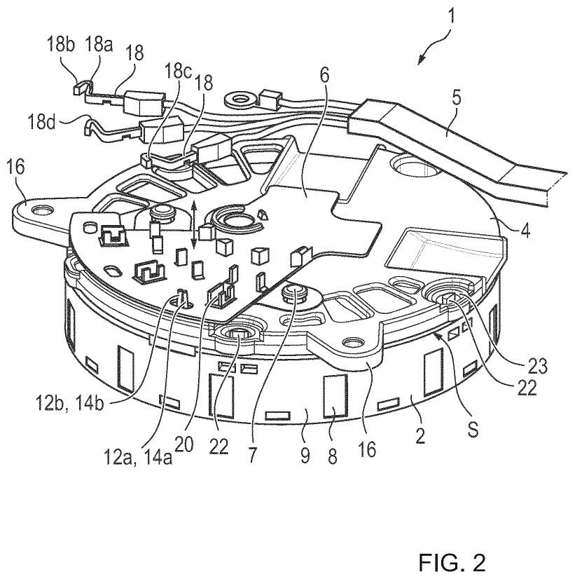

Referring now to the figures of the drawings in detail and first, particularly to FIGS. 1 and 2 thereof, there is shown an electric motor 1, configured as an internal-rotor motor, containing a stator 2, a rotor 3, a motor support 4 and a connecting cable 5. A base plate 6 is provided on the side of the motor support 4 opposite the stator 2. In the assembled state of the electric motor 1, the base plate 6 is connected to the motor support 4, preferably by means of screws 7. The electric motor 1 is in particular provided as a drive motor (cooling fan motor) for a cooling fan of a motor vehicle.

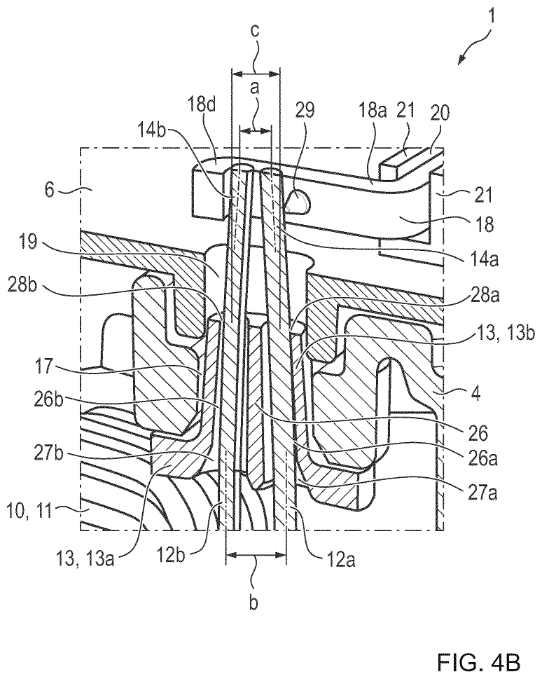

The stator 2 has a main stator body 8, which is overmolded with a plastic jacket 9. The stator 2 or its main stator body 8 has stator teeth, not visible here, projecting inward in the radial direction R. Arranged on these are coils 10 which can be seen in FIGS. 4A and 4B and which are connected to one another to form a stator winding or rotating-field winding 11. The stator winding 11 has winding ends 12a, 12b as phase connections for the phase-selective, for example three-phase, energization of the stator winding 11.

For reasons of clarity, only one connection pair comprising two winding ends 12a, 12b of the stator winding 11 are shown in the figures. The winding ends 12a, 12b used in pairs as phase connections project beyond the stator 2 in the axial direction A (axially) at one end S and are initially oriented parallel to one another.

The rotor 3, which is arranged within the annular stator 2 and is rotatably mounted about an axis of rotation D, has a number of permanent magnets in a manner not specifically illustrated. As a result of the energization of the stator winding 11 with a, for example, three-phase alternating current, the latter produces a magnetic rotating field. The rotor-side permanent magnets generate a rotor magnetic field interacting with the rotating field of the stator 2.

A wire holder 13 is assigned to the winding ends 12a, 12b for their alignment. In a three-phase electric motor 1 with three phase connections, three such wire holders 13 are provided. Via the wire holders 13, the winding ends 12a, 12b are guided in pairs as a connection pair. The two winding ends 12a, 12b are forcibly guided from an initially parallel orientation into an alignment facing one another. Because of the forcible guidance within the wire holder 13, the two winding ends 12a and 12b are inclined toward one another. The distance a (FIG. 4B) between the winding ends 12a and 12b emerging from the wire holder 13 decreases increasingly in the axial direction A as far as their connecting sections 14a, 14b at their free ends. The respective wire holder 13 is arranged on the annular edge 15 on the front face of the stator 2 and the overmolded main stator body 11.

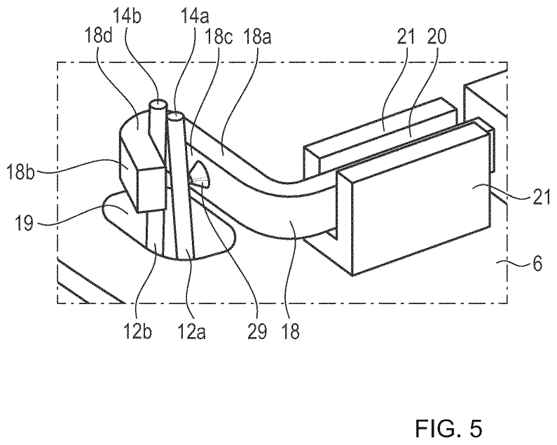

The in particular plate-like or half-shell-shaped motor support 4 is suitably a one-piece (single-part) pressure die casting made of aluminum. The motor support 4 has flange-like connecting lugs 16 projecting radially beyond the stator 2 for the screw-fastening of the electric motor 1 to a vehicle part of the motor vehicle. The motor support 4 has a number of passage openings 17 corresponding to the number of phase connections, via which the winding ends 12a, 12b aligned by means of the respective wire holder 13 are guided to connecting contacts or contact elements 18 on the cable side. These are hook-shaped with a connecting leg 18a on the cable side and with a free or clamping leg 18b bent in a U shape with respect to the latter (FIG. 5).

The base plate 6 has through openings 19 aligning with the passage openings 17 of the motor support 4 for the winding ends 12a, 12b aligned by means of the respective wire holder 13. The connecting contacts 18 are inserted into press-in slots 20 in the manner of a press fit on the upper side of the base plate 6 facing away from the stator 2. The base plate 6, preferably produced from a plastic as an injection-molded part, has to this end axially protruding webs or (axial) ribs 21, between which the respective connecting contact 18 is accommodated, forming a press fit. The connecting contact 18 is positioned in such a way that the contact or connection space 18c formed between its connecting leg 18a and the free or clamping leg 18b is aligned with the through opening 19 in the base plate 6 and with the passage opening 17 in the motor support 4.

The stator 2 is fastened to the motor support 4 by means of mortise studs 22, which are formed from the plastic jacket 9 in the area at the annular edge 15 on the front face and project beyond the main stator body 11 in the axial direction A. The mortise studs 22 on the stator side correspond with mortise openings 23 of the motor support 4. In the joined state shown in FIG. 2, the stator-side mortise studs 22 reach through the support-side mortise openings 23 in order then to be mortised.

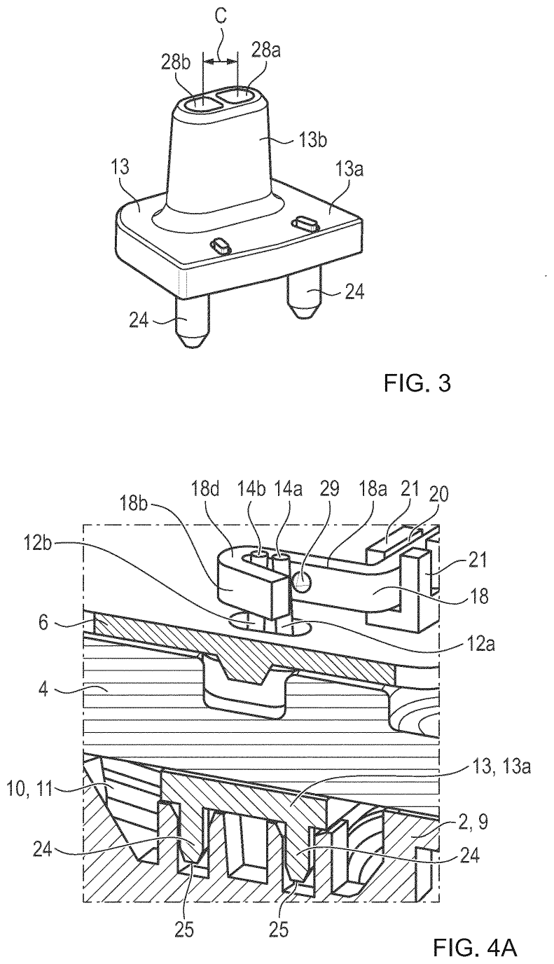

FIG. 3 shows the wire holder 13 in a perspective illustration. FIGS. 4A and 4B show the wire holder 13 mounted and penetrated by the winding ends 12a and 12b as a connection pair in different axial longitudinal sections. FIG. 5 shows the winding ends 12a and 12b guided into the connecting contact 18 and angled toward one another.

The wire holder 13 has a plate-like contact portion 13a and a dome-like guide portion 13b molded on the latter for the winding ends 12a and 12b of the stator winding 11. In the exemplary embodiment, two plug-in pins are molded on the contact portion 13a as joining elements 24. These are inserted into two joining contours 25 shaped like blind holes—extending axially—to hold the wire holder 13 on the stator 2. These contours are introduced into the plastic jacket 9 at or on the annular edge 15 on the front face of the stator 2.

As can be seen from FIG. 4B, the wire holder 13 has a guide contour 26 holding the winding ends 12a and 12b, which tapers conically toward the motor support 4. In the exemplary embodiment, the guide contour 26 is formed from two passage or guide channels 26a, 26b extending at an angle or obliquely relative to one another for a respective one of the winding ends 12a, 12b of a respective connection pair of the stator winding 11. The passage channels 26a, 26b of the wire holder 13 have inlet openings 27a, 27b at a distance from one another for the winding ends 12a and 12b, and outlet openings 28a, 28b at a distance from one another, via which the winding ends 12a, 12b emerge from the wire holder 13 in the alignment inclined properly relative to one another. The distance b between the inlet openings 27a, 27b is greater than the distance c between the outlet openings 28a, 28b.

The wire holder 13 aligns the accommodated winding ends 12a, 12b with a common (imaginary) tip. The winding ends 12a, 12b are guided by means of the wire holder 13 in such a way that their distance a from one another decreases, starting from the inlet via the inlet openings 27a, 27b in the wire holder 13 to the outlet openings 28a, 28b and, moreover, in the axial direction A. In this orientation, the winding ends 12a, 12b led out of the wire holder 13 are guided to the connecting contact 18 and there, between the connecting leg 18a and the free or clamping leg 18b, into the holding or contact space 18c. Contact between the winding ends 12a, 12b and the connecting contact 18 is then produced, preferably automatically, by means of a welding process. For this purpose, for example, use is made of welding tools which, in the course of the welding process, press the two legs 18a and 18b of the connecting contact 18 together.

In the assembled state of the electric motor 1, the winding ends 12a, 12b aligned by means of the wire holder 13 and emerging from the latter are guided between the connecting leg 18a and the free or clamping leg 18b of the connecting contact (contact element) 18 extending at a defined distance from the latter into the contact or connection space 18c.

To further improve the positioning of the aligned winding ends 12a, 12b in the connection or contact space 18c of the connecting contact 18, in the exemplary embodiment its connecting leg 18a has a contact element 29 in the form of a supporting stud or supporting cone as a positioning aid for at least one of the winding ends 12a, 12b-here of the winding end 12a facing the opening between the legs 18a and 18b of the connecting contact 18.

The contact element 29 is shaped out of the connecting leg 18a and projects in the direction of the free or clamping leg 18b. Thus, within the contact space 18c between the contact element 29 and the transition leg 18d from the connecting leg 18a to the clamping leg 18b, a defined connecting area is provided. In this area, the winding ends 12a, 12b are positioned with their connecting sections 14a, 14b guided toward one another. Because of the alignment of the winding ends 12a, 12b effected by the wire holder 13, one of the winding ends 12a, 12b or one of the connecting portions 14a, 14b is prevented from being able to emerge or escape from the contact space 18c or from the connecting area laterally delimited by the contact element 29 in the course of the contact making or the welding process.

In summary, the invention relates to an electric motor 1, having a stator 2 with a stator winding 11, of which the winding ends 12a, 12b project beyond the stator 2 at one end(S) as phase connections and are aligned axially in pairs, a rotor 2, a motor support 4 with passage openings 17 for the phase connections, a connecting cable 5 with connecting contacts 18 for making contact with the winding ends 12a, 12b, and a number of wire holders 13, through which the winding ends 12a, 12b are guided in pairs and into a mutually facing alignment.

The claimed invention is not restricted to the exemplary embodiments described above. Thus, it is also possible to provide wire holders which are provided and configured to guide more than two winding ends 12a, 12b, for example three winding ends, of the stator winding 11 jointly and to align them at an angle to one another.

The following is a summary list of reference numerals and the corresponding structure used in the above description of the invention:
1 Electric motor
2 Stator
3 Rotor
4 Motor support
5 Connecting cable
6 Screw
7 Base plate
8 Main stator body
9 Plastic jacket
10 Coil
11 Stator/rotating-field winding
12a, 12b Winding end/connection pair
13 Wire holder
13a Contact portion
13b Guide portion
14a, 14b Connecting section
15 Annular edge
16 Connecting lug
17 Passage opening
18 Connecting contact/contact element
18a Connecting leg
18b Free/clamping leg
18c Holding/connection space
18d Transition leg
19 Through opening
20 Press-in slot
21 Web/rib
22 Mortise stud
23 Mortise opening
24 Joining element/plug-in pin
25 Joining contour
26 Guide contour
26a, 26b Passage/guide channel
27a, 27b Inlet opening
28a, 28b Outlet opening
29 Contact element/supporting stud/cone
A Axial direction
a,b,c Distance
D Axis of rotation
R Radial direction
S End

1. An electric motor, comprising:
a stator overmolded with a plastic jacket, said stator having a stator winding with winding ends, said winding ends projecting beyond said stator at one end as phase connections and being aligned axially in pairs;
a rotor rotatably mounted about an axis of rotation with respect to said stator;
a motor support having a plurality of passage openings formed therein and corresponding to a number of said phase connections;
a connecting cable with connecting contacts for making contact with said winding ends; and
a plurality of wire holders corresponding to the number of said phase connections disposed on said one end of said stator, through said wire holders said winding ends are guided in pairs.

2. The electric motor according to claim 1, wherein each of said wire holders has a plate-shaped contact portion and a guide portion molded thereon for said winding ends.

3. The electric motor according to claim 2,
wherein said stator has a main stator body;
wherein at least of one of said main stator body or said plastic jacket has a front face with joining contours formed therein; and
further comprising at least one pin-shaped joining element being molded onto said plate-shaped contact portion, said at least one pin-shaped joining element being inserted into one of said joining contours on said front face of said plastic jacket and/or said main stator body to hold said wire holders on said stator.

4. The electric motor according to claim 1, wherein:
a respective wire holder of said wire holders has a guide contour holding said winding ends, said guide contour tapers conically toward said motor support; and/or
said respective wire holder has at least two passage channels formed therein and extending at an angle or obliquely relative to one another for each of said winding ends.

5. The electric motor according to claim 1, wherein a respective wire holder of said wire holders has at least two inlet openings formed therein at a distance from one another and at least two outlet openings formed therein at a distance from one another, wherein the distance between said outlet openings is smaller than the distance between said inlet openings.

6. The electric motor according to claim 1, wherein said connecting contacts for making contact with said winding ends are hook-shaped with a connecting leg assigned to said connecting cable and with a free or clamping leg bent over approximately in a U shape.

7. The electric motor according to claim 6, wherein a respective one of said connecting contacts has at least one molded-on contact element as a positioning aid for one of said winding ends.

8. The electric motor according to claim 7, wherein said at least one molded-on contact element is a supporting stud or supporting cone shaped out of said connecting leg and elevated in a direction of said free or clamping leg.

9. The electric motor according to claim 1, further comprising:
a base plate having through openings formed therein and aligning with said passage openings of said motor support for said winding ends aligned by means of said wire holders; and/or
said base plate having press-in slots formed therein for holding and/or positioning said connecting contacts.

10. The electric motor according to claim 1, wherein:
the electric motor is a cooling fan motor for a motor vehicle; and
said winding ends are guided through said wire holders from a parallel orientation into a mutually facing alignment.

11. The electric motor according to claim 1, wherein a respective wire holder of said wire holders has passage channels formed therein, said passage channels have at least two inlet openings at a distance from one another and at least two outlet openings at a distance from one another, wherein the distance between said outlet openings is smaller than the distance between said inlet openings.

12. A cooling fan of a motor vehicle, comprising:
the electric motor according to claim 1.
